(19) United States
(12) Patent Application Publication
(10) Pub. No.: US 2010/0001895 A1
(43) Pub. Date: Jan. 7, 2010

(54) METHOD AND APPARATUS FOR DETERMINING DME REPLY EFFICIENCY

(75) Inventor: Michael John Leeson, Malvern (GB)

Correspondence Address: OLIFF & BERRIDGE, PLC, P.O. BOX 320850, ALEXANDRIA, VA, 22320-4850, US

(73) Assignee: QINETIQ LIMITED, London (UK)

(21) Appl. No.: 12/442,568

(22) PCT Filed: Oct. 12, 2007
(86) PCT No.: PCT/GB07/03887

§ 371 Date: Mar. 24, 2009

(30) Foreign Application Priority Data
Oct. 12, 2006 (GB) 0620192.5

(51) Int. Cl. G01S 13/91; G01S 13/78

(52) U.S. Cl. 342/36; 342/47

(57) ABSTRACT

This invention relates to a method for determining the reply efficiency of a DME navigation beacon and to an apparatus for performing the method. The invention involves locating an RF receiver nearby a DME beacon to be tested. The RF receiver analyses all signals received on the interrogation frequency of that beacon to determine pulse pairs which correspond to a valid interrogation of that beacon. Other pulse events of interest may also be detected. The RF receiver also records all signals on the reply frequency of the beacon and detects all replies sent by the beacon. Particular interrogations can then be correlated with replies and the reply efficiency of the beacon determined. Several RF receivers may be located round the beacon to better provide correlation between particular interrogations and responses.

This invention relates to a method and an apparatus for determining the reply efficiency of radio frequency (RF) navigational aids, in particular to a method and apparatus for determining any interference with regard to Distance Measuring Equipment (DME) beacons.

Distance Measuring Equipment (DME) is a technique for aircraft navigation which is part of the civil air navigation infrastructure. DME beacons are provided at known ground locations to provide reference points for aircraft travelling in the airspace above. Aircraft routinely interrogate these DMEs and determine their position from the replies received.

The DME apparatus comprises two parts, an interrogator located on board a relevant aircraft and a transponder within the beacon located at a known ground location. In use the airborne interrogator transmits a series of RF pulse pairs at a particular interrogation frequency. In order that the beacon transponder can identify a valid interrogation each pulse has a specific width and the pair of pulses has a specific spacing. It should be noted that different modes of operation of DME beacons use a different pulse pair spacing but for a beacon operating in a particular mode the separation is fixed.

The ground based DME transponder receives various RF signals and tries to identify any pulse pairs which constitute an interrogation. As mentioned the pulse pair has a specific spacing and pulse width and so the beacon processes all signals received to see if a pulse of the right width is followed after the correct spacing by another pulse of the correct width. Once it has identified a pulse pair as being received from an airborne interrogator the beacon will transmit a pulse pair on a specified reply frequency after a specific time delay. Again the reply pulses have a specific width and a specific spacing between the pulses in the pair which depends on the mode of operation.

A DME beacon may be interrogated by several aircraft at the same time. The DME beacon does not distinguish between pulse pairs received from any particular aircraft and responds to any valid pulse pair. As the beacon responds to pulse pairs from several aircraft the interrogator located on board an aircraft sends a pulse pair sequence having random timings between pulse pairs which will be unique to that aircraft. The airborne interrogator, having transmitted a particular pulse pair sequence starts looking for a reply, on the reply frequency, of that transmitted pulse sequence and, if it does detect the correct reply sequence, determines the delay between transmission and receipt of the pulse pairs. This delay is equal to the time of flight of the pulse pairs plus the known specified delay between reception and reply introduced by the beacon. Therefore the actual time of flight can be calculated and from this the straight line distance to the beacon can be determined.

The DME beacon can handle about one hundred or so different aircraft interrogations and can control its own loading by reducing its sensitivity. Therefore the beacon monitors its loading level and if it is overloaded with aircraft interrogations it reduces its sensitivity to interrogations. This in effect means that it responds to the closest aircraft. If the beacon does reduce its sensitivity the reply efficiency, i.e. the measure of how many interrogation pulses sent by an interrogator receive a reply, also goes down. If there is any source of RF interference which is received at the beacon and which it mistakes as a valid interrogation this could therefore lead the beacon to think it is more highly loaded than it is and will reduce the reply efficiency. Thus interference at the DME beacon can effect its operational effectiveness.

Further once a DME beacon has detected a valid interrogation pulse it ceases to process any further pulses for a short period thereafter. This short period is intended to avoid the DME beacon responding to an echo of the valid interrogation. Any new interrogation pulse incident at the transponder during this time will not be processed and hence no reply will be sent. Thus not every pulse pair transmitted by the interrogator on an aircraft may be replied to as some may be incident at the beacon transponder whilst the transponder is processing a different interrogation. The beacon performance takes this fact into account and is expected to reply to 70% of valid interrogations from an aircraft interrogator. This does mean of course that if any interference is deemed to be an interrogation pulse by the beacon transponder not only will the loading of the beacon be increased but the beacon will be non receptive to valid interrogations following the interference and the operational effectiveness will be reduced.

Sources of interference could be any other source of RF transmission, although as will be understood from the foregoing the beacon will not reply to interrogation pulses that don't have the correct width and spacing.

It will therefore be clear that satisfactory operation of the DME network could be compromised by overloading a beacon with interference. Whilst the beacons themselves have an internal measure of reply efficiency and are equipped with alarms in case reply efficiency falls below acceptable levels the beacons can't classify the type or possible source of interference. This is important not only in that if a beacon is experiencing interference it would clearly be beneficial to identify the cause of interference in order to try and reduce it but also in terms of frequency clearance of use of other RF equipment. For instance it may be desired to use other communication systems within the same waveband of operation of the DME network. If such other equipment does not produce DME like pulses its effect on the DME network may be minimal. However to date there is no known method for assessing the effect of other systems on the DME network. For instance in the military sphere the use of the Joint Tactical Information Distribution System (JTIDS), which shares the same frequency band as DMEs, is increasing and there is a desire to show what effect, if any, use of the JTIDS system has on the operation of the DME network.

It is therefore an object of the invention to provide a method and apparatus for assessing the degree of interference in operation of a DME transponder and in particular to a method which can identify the cause of any interference and/or assess the impact of use of other radar/radio equipment on the reply efficiency of a DME transponder.

Thus according to the present invention there is provided a method of monitoring the operation of a DME transponder comprising the steps of: arranging an RF receiver to receive substantially the same RF signals as received by the DME beacon on its interrogation frequency and to receive any RF signals transmitted by the beacon on its reply frequency; processing the RF signals received on the interrogation frequency to identify any DME pulse pair interrogations; processing the RF signals received on the reply frequency to identify any DME pulse pair replies; and calculating a reply efficiency for the DME transponder.

The method of the present invention therefore provides a non-invasive, remote method of providing an external measure of reply efficiency by measuring the RF traffic between the DME beacon and any DME interrogators. The method of the present invention therefore provides no disruption to the normal operation of the DME network.

As well as identifying DME interrogations the method may involve processing the RF signals received on the interrogation frequency to identify any pulse events of interest. The pulse events of interest may be RF signals matching predetermined characteristics such as being similar to DME interrogation signals. In other words the processing on the interrogation frequency channel could also identify any DME like signals which could be a source of potential interference. The predetermined characteristics could alternatively or additionally be characteristic of a known RF communication system. For instance if it is wished to investigate the effect, if any, of a particular RF system on the operation of the DME beacon, for the purposes of frequency clearance, it will be desirable to monitor the activity of that known system. The known system could be any RF communication system such as the JTIDS communication system, in which case the pulse events of interest include JTIDS communication pulses.

Analysis of the RF signals involves looking at the pulse characteristics, such as pulse width, rise time, any pulse shape characteristics, and pulse pair spacing. As the pulses are quite short it is necessary to sample the signals received at a very high rate to capture enough information. However high sampling rates lead to a very large amount of data to record or transmit. To reduce the data storage requirements the method of the present invention only stores or transmits data relating to identified DME interrogation pulses, identified DME reply pulses and any non-DME pulse events of interest for subsequent analysis. The data transmitted or stored comprises data regarding shape of the pulse and the time of arrival. Whether the data is stored or transmitted will depend on the apparatus used. A simple data recording apparatus could be used in the field to record the signals and apply the initial processing to record only pulse data. This could be stored in some storage medium for later collection or could be transmitted via a communication link to an analysis facility. Alternatively the RF receiver could be combined with a processor to perform in situ analysis.

A very simple measure of reply efficiency may be obtained by counting the incoming interrogations and number of replies. However it is preferable to be able to identify which reply corresponds to which interrogation as this allows more detailed analysis. The method may therefore involve the step of correlating identified DME pulse pair replies with the relevant DME pulse pair interrogation. When the RF receiver is co-located with the DME beacon the correlation step is straightforward and simply involves identifying which interrogation pulse pair was received the fixed delay time prior to transmission of the reply pulse pair. If the RF receiver is spaced apart from the DME beacon however correlation is not so straightforward. In this case the DME beacon and RF receiver may be at slightly different distances to the aircraft interrogators and hence the interrogations may be received at different times by the DME beacon and the RF receiver. Further the distance between the DME beacon and the RF receiver will introduce a slight delay between a reply being transmitted by the DME beacon and it being received at the RF receiver. Whilst the distance between the RF receiver and the DME beacon can be measured and accounted for the aircraft location is unknown. The processor therefore takes account of the physical separation from the beacon and applies a tolerance to the arrival time of a reply following the arrival time of an interrogation.

As mentioned above given a separation between an RF receiver and the DME beacon there will be a degree of uncertainty in the time of arrival of signals at the DME beacon. This uncertainty can be removed by using more than one RF receiver, each being located at a different location. The different time of arrival of the signals at each RF receiver can be used as part of the correlation process. The method may therefore involve the step of locating at least one additional RF receiver to receive the same RF signals as received by the DME beacon on its interrogation frequency and to receive any RF signals transmitted by the beacon on its reply frequency. The method may involve the step of correlating the signals received at each RF receiver to determine the time of arrival of the signals at the DME beacon.

The method may apply the principles of multilateration. The skilled person will appreciate that multilateration is a known technique for determining the location of a source of radiation by using the time of arrival at various sensors. In order to apply multilateration techniques one must be able to identify a particular event. Due to the large amount of DME pulses being generated and the fact that DME interrogation pulses are generally indistinguishable from one another it would be difficult to correlate a particular pulse arriving at one RF receiver with the same pulse arriving at another RF receiver. Therefore the method preferably uses a reply from the DME beacon to indicate an event. The reply can be correlated with a particular interrogation pulse at each receiver by applying a tolerance as described above. Each RF receiver with therefore measure a different time delay between the interrogation and reply. The time difference between interrogation and reply as measured at each RF receiver can be determined and compared with that which would be expected, given the separation between that particular DME beacon and the RF receiver, had the signals been received at the same time at the RF receiver and DME beacon. Any difference represents a Time Difference of Arrival (TDOA). The TDOA for each RF receiver can be determined and processed using a multilateration algorithm as will be understood by one skilled in the art and the location of the source of those pulses can be determined. Once the location of a particular aircraft is known the pulses emitted by that aircraft can be identifying by looking for pulses which arrive at each of the RF receivers with the correct relative timing. The exact time at which such pulses arrive at the DME beacon can also be determined.

The technique of multilateration can not only be applied to genuine interrogations from aircraft interrogators but also to sources of interference or potential interference, as will be described later.

Having identified each reply with an interrogation pulse the operation of the DME beacon can be assessed against its expected mode of operation. For instance interrogations received during dead time would not be expected to generate a reply. Looking at valid interrogations that didn't receive a reply can indicate the sensitivity level of the beacon or indicate periods where there may have been interference.

Further analysis can be performed by modelling how the DME beacon is behaving. Details of the identified DME pulse pair interrogations, DME pulse pair replies and pulse events of interest may therefore be input into a model of the DME beacon. The model could be implemented in software or hardware and would model the DME beacon's response to the input signals, it's own internal measure of reply efficiency and internal sensitivity adjustments. Using a DME model enables the reply efficiency for a single interrogator to be determined. This is achieved by generating a set of monitor interrogations and feeding these into the DME model along with the external interrogations. The replies generated for the monitor interrogations can be identified and the reply efficiency for the monitor determined.

The reply efficiency may be analysed to determine any correlation with pulse events of interest. For instance if the method is being used for frequency clearance purposes, say for use of JTIDS, it may be wished to determine whether the level of JTIDS activity is correlated with reply efficiency in any way.

The method of the present invention therefore provides a simple non-invasive way of monitoring the operation of a DME beacon. It can measure the beacon reply efficiency and model how the beacon is behaving. Further the impact of any possible interference can be judged and the method can look for RF signals specifically corresponding to a known system to determine whether they have any impact on the reply efficiency. The method of the present invention there provides a method of performing frequency clearance checks on the DME network.

The present invention also provide apparatus for monitoring the operation of a DME beacon comprising an RF receiver for receiving RF signals at the interrogation frequency of the DME beacon and RF signals at the reply frequency of the DME beacon, an input data processor for processing the RF signals incident at the interrogation frequency to identify any DME interrogation pulse pairs and processing the RF signals incident at the reply frequency to identify any DME reply pulse pairs and storing pulse data relating to identified DME pulse pairs.

All of the advantages and embodiments of the method described above apply to the apparatus. In particular the input data processor may also process the RF signals incident at the interrogation frequency to identify any pulse events of interest and stores pulse data relating to identified pulse events of interest to reduce data storage/transmission requirements. The stored pulse data may comprise information used to determine pulse shape and time of arrival.

The apparatus may further comprise a pulse data processor for correlating identified DME reply pulses with identified DME pulse interrogations in the manner described above and as will be more fully explained later.

The pulse data processor may produce an indication of the DME beacon reply efficiency. It may also correlate pulse events of interest with the reply efficiency of the beacon. As mentioned above the processing of the pulse data may be performed remotely to the RF receiver and the apparatus may comprise a storage medium for storing the pulse data and/or a transmission link for transmitting the pulse data to a remote processing facility. The apparatus may however process the pulse data on site and in this case the input data processor may or may not be the same processor as the pulse data processor.

Where the apparatus does perform pulse data processing it may further comprise a model means acting on the pulse data for modelling the operation of the DME beacon and for determining elements of the DME performance such as beacon reply efficiency and interrogator reply efficiency. Beacon Reply Efficiency is the ratio of replies transmitted by the beacon to the total number of valid interrogations received. Interrogator Reply Efficiency is the ratio of replies received by a single interrogator to the number of interrogations that it sent out. Beacon RE is the average of all interrogator RE.

The invention has been described above with reference to monitoring operation of a DME beacon. The invention is generally applicable to other types of radio navigation aid however such as ILS or SSR systems, or even more generally to any type of RF communication system. Thus the present invention may provide a method of monitoring the operation of an RF communication apparatus, especially a radio navigation aid, involves the step of arranging an RF receiver to receive substantially the same RF signals as received at, and/or transmitted by the RF communication apparatus, processing the RF signals received to identify signals corresponding to normal operation of the RF communication apparatus and any signals having a predetermined characteristic of interest and determining any reduction in efficiency or interruption of the RF communication apparatus. The method may also involve determining any correlation of any reduction in efficiency or interruption of the RF communication apparatus with instances of signals having the predetermined characteristic of interest.

Note that the method of applying the techniques of multilateration to interrogation reply events as measured by a plurality of analysers of the present invention is also novel. Previously it has been thought that, as each DME pulse is substantially identical, multilateration techniques were not applicable to DME pulses. The present inventors however have realised that using the DME reply to identify a pulse event which can be analysed using multilateration techniques. Therefore another novel method according to the invention is the method of arranging a plurality of RF receivers around a DME beacon, each being arranged to receive substantially the same RF signals as received by the beacon on the interrogation frequency and transmitted by the beacon on the reply frequency, processing the signals received at each RF receiver to determine a reply pulse pair transmitted by the DME beacon and identify the relevant interrogation pulse pair received, determining a time difference of arrival for the relevant interrogation pulse pair at each RF receiver relative to the DME transponder and performing multilateration using each determined time difference of arrival to determine the relative location of the source of the relevant interrogation pulse.

As mentioned above the technique of multilateration can also be applied to non DME pulses, for instance JTIDS pulses operating in the DME frequency Band. As also mentioned above there may be a need to assess the impact of JTIDS traffic or other possible sources of interference on the efficiency of one or more DME beacons. If JTIDS traffic, for example, is found to be interfering with the satisfactory operation of a DME beacon it may be desirable to identify the origin of the interference to aid in assessing the overall impact. As discussed above to be able to perform multilateration on potentially interfering pulses it is necessary to uniquely identify the time of arrival of particular pulses at different RF receivers. This requires one to be able to identify which pulses received at the separated RF receivers correspond to the same transmission event.

JTIDS operates by transmitting pulses on 51 frequencies in the 960-1215 MHz band. Each pulse is transmitted on a different frequency and the frequency pattern is pseudo random. Each pulse contains 32 bits of data obtained from encrypting the data that requires transmitting. In order to detect, characterise and multilaterate on JTIDS pulses the invention can be tuned to one specific JTIDS operating frequency and the pulses present on that frequency are then considered as representative of the whole JTIDS operating spectrum. In order to multilaterate on JTIDS pulses the arrival time of the pulses has to be determined and the pulse has to be uniquely labelled so that the arrival times at each of the receiving sensors can be correlated.

It is not possible, or desirable, to extract and decode the transmitted information without gaining access to the network. However, it is known that at some time a pulse will be transmitted on a specific channel and that this pulse will contain some information. Such a pulse can be detected and the 32 bits (or chips as they are known) of information contained therein can be determined even if the meaning of those 32 chips is unknown.

In another aspect of the present invention therefore there is provided a method of identifying a source of non-DME pulses transmitted within the DME frequency band comprising the steps of: locating a plurality of RF receivers at spatially separated locations, detecting, for at least one predetermined frequency channel, any pulses received on that frequency channel; processing each pulse received to derive a label based on the pulse modulation; using said pulse labels to identify the time of arrival of said pulse at each RF receiver; and performing multilateration on the identified times of arrival. The method may include the step of ignoring any pulses which do not match a predetermined characteristic. For instance when locating the source of JTIDS pulses the method may analyse pulses received and only process those which match the duration and general modulation characteristics of JTIDS pulses.

The receiver is able to detect the frequency modulation within the JTIDS pulse and determine the 32 chip sequence of that pulse. A sensor consisting of a receiver and a clock can determine the time of arrival (TOA) of a single JTIDS pulse and can “label” the pulse with the unique 32 bit number obtained from the receiver. A message containing the 32 bit label and the TOA can be generated and sent to a multilateration system.

The multilateration system takes the messages from several sensors and determines the position of the platform. A set of TDOAs is all that is required for determining the position using multilateration.

The invention will now be described by way of example only with respect to the following drawings, of which:

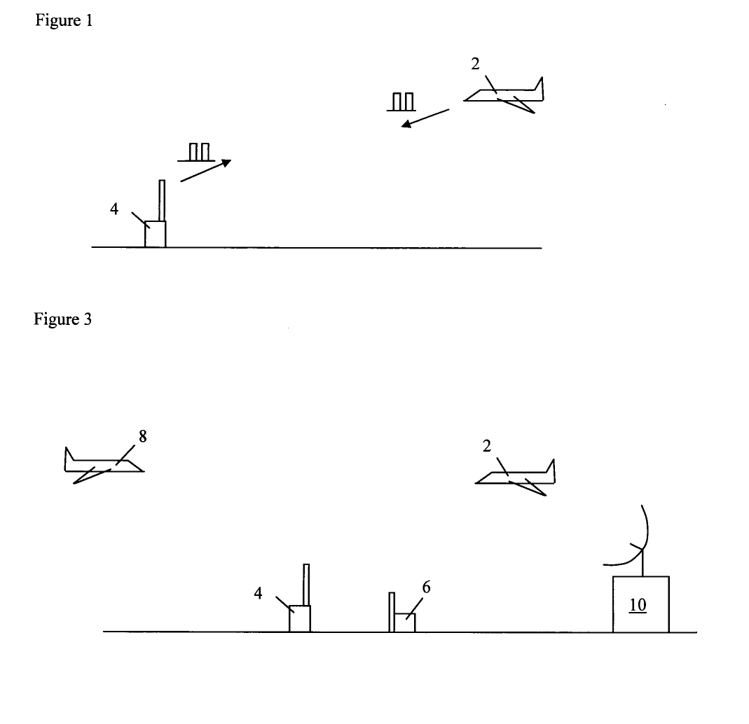

FIG. 1 shows a schematic of the principles of operation of a DME beacon,

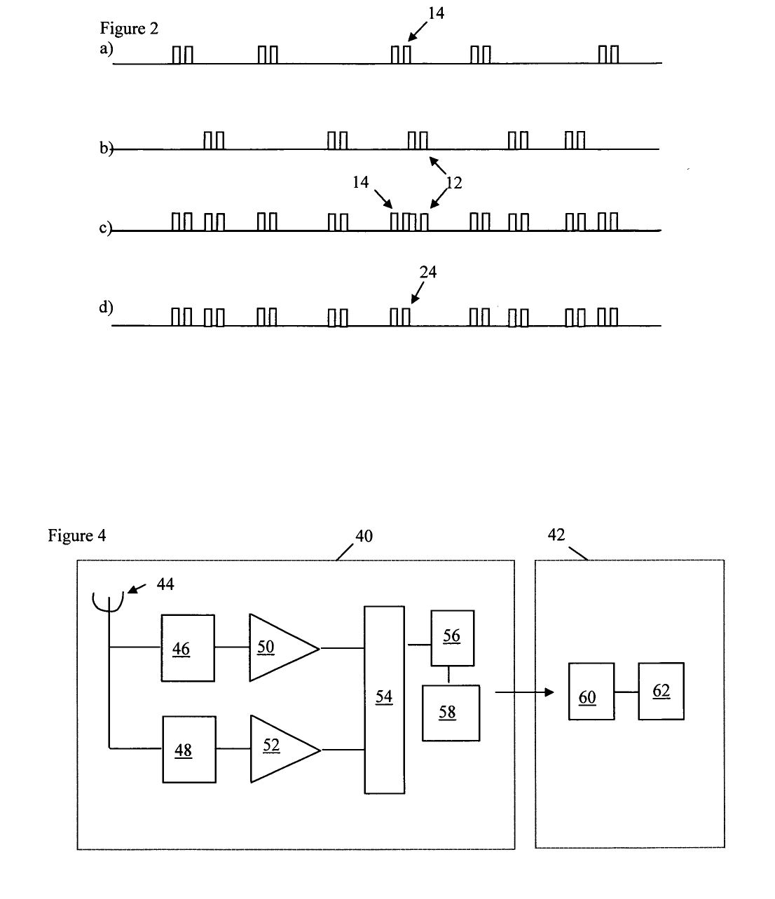

FIG. 2 illustrates pulse sequences of transmission and reply,

FIG. 3 illustrates the principle of operation of the present invention,

FIG. 4 shows a schematic of an embodiment of the present invention,

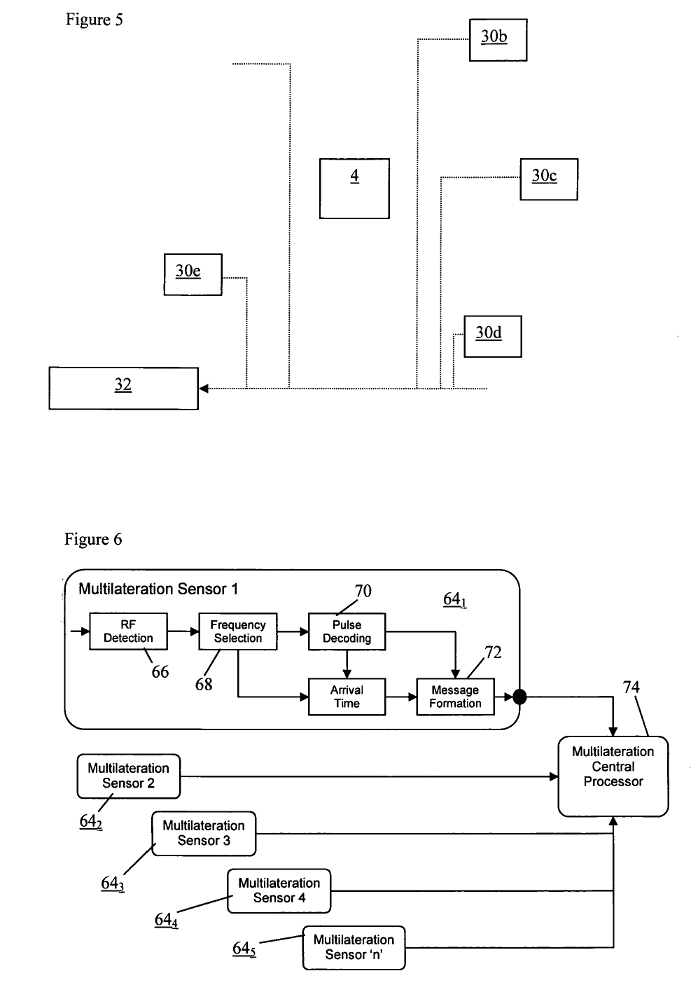

FIG. 5 shows an embodiment of the invention having multiple analysers arranged around a DME beacon, and

FIG. 6 shows the method of multilateration on JTIDS pulses

Referring to FIG. 1 the basic principle of operation of a DME beacon is illustrated. An aircraft 2 is equipped with a DME interrogator for interrogation of a ground based DME beacon transponder 4. The DME beacon is located in a known fixed location, such as an airport runway which may be the aircraft's destination. DME beacons are often co-located with other aviation navigational aids such as VOR (VHF omnidirectional Receiver) systems, which provide an indication of the angle of the aircraft to the VOR, relative to north, or ILS (Instrument Landing Systems) which aid correct landing approaches. Each DME beacon will have a particular operating frequency in the range 962-1213 MHz which, when the beacon is co-located with a VOR/ILS system will generally be paired to the VHF frequency of operation of the VOR/ILS.

The aircraft interrogator is tuned to the correct interrogation frequency for the particular DME beacon and transmits a series of pulse pairs. Each pulse is 3.5 μs wide and the separation between pairs is 12 μs for X-channel mode or 36 μs for Y-channel mode.

The transponder 4 receives incident radiation and analyses anything that looks like a pulse to determine whether it has the correct width. If a valid pulse is detected the receiver shuts itself down, to prevent short distance echoes of the pulse being detected, and wakes itself up in time to detect the second pulse. The receiver is effectively deaf during these periods of Short Distance Echo Suppression (SDES). If a second pulse is detected the receiver will shut down again but will also start the process of generating a reply. During the process of generating and transmitting a reply, the transmitter is prevented from generating any pulses except the required reply pulses and this period is known as “DME dead time”. In normal use the DME beacon will generate reply pulses in the absence of a valid interrogations but these are inhibited during the dead time period. The DME dead time is typically 60 μs.

In processing the valid interrogation the transponder applies a fixed time delay and then responds with a pulse pair on a reply frequency which is 63 MHz above or below the interrogation frequency depending on the specific DME being used. The pulse pair width and spacing are again fixed for a particular operating mode.

The aircraft interrogator, having sent a series of pulse pairs waits to determine if the DME transponder replies to that series of pulses on the reply frequency. If it detects that the transponder has replied to the interrogation series it determines the time delay between transmission and receipt and, taking the fixed delay introduced by the beacon into account, converts that time delay into a distance.

Given that the transponder may well be responding to several aircraft at the same time and each pulse pair transmitted by the transponder in reply is identical, each aircraft introduces its own random variation in the time between one pulse pair and the next. FIG. 2 illustrates this concept by showing pulse sequences emitted by two different aircraft, the pulses received at the transponder and the corresponding replies. Note though that the pulse train shown in FIG. 2 are illustrative only and not meant to be indicative of the actual pulse shapes or relative pulse spacings.

A first aircraft transmits a first series of pulse pairs with random spacings as shown in FIG. 2a. A second aircraft also transmits a random sequence of pulse pairs as shown in FIG. 2b. Although each pulse pair transmitted by each aircraft is identical the spacing between the pairs is unique to each aircraft. The transponder receives both pulse sequences as shown in FIG. 2c.

The transponder processes all signals received at the receive channel at the correct frequency and attempts to identify a pulse pair indicating a valid interrogation. For each valid interrogation pulse received it effectively switches off the receive channel for a short period of time before switching back on at the correct time to determine if there is a second valid interrogation pulse at the correct spacing. If a valid interrogation pulse pair is detected the transponder introduces a fixed delay and then transmits a reply pulse pair on the reply frequency. FIG. 2d shows the pulse pairs emitted on the reply channel after the fixed delay. It can be seen that the pulse sequence output on the reply channel is substantially the same as that incident on the transponder shown in FIG. 2c. However the transponder does not necessarily respond to every pulse pair. For instance pulse pair 12 which was transmitted by the second aircraft does not receive a reply. This is because the first pulse of pulse pair 12 were received at the transponder very shortly after the second pulse of pulse pair 14, emitted by the first aircraft was received. Pulse pair 14 was correctly identified as a valid interrogation and the DME beacon transponder replied to that pulse pair with reply pulse pair 24. The first pulse of pulse pair 12 arrived at the transponder during the dead time following identification of the second pulse of pulse pair 14 as a valid interrogation. Therefore the first pulse of pulse pair 12 was ignored and hence pulse pair 12 is not recognised as a valid interrogation pulse pair.

The reply sequence shown in FIG. 2d is received by both aircraft. Each aircraft, knowing its own random sequence, applies a gating algorithm and identifies a reply to its own pulse sequence. The interrogator on each aircraft then calculates the total time delay between transmission and receipt and determines a distance to the beacon. Although the pulse sequence from the second aircraft did not receive a complete response the interrogator can still identify a reply to its interrogation sequence.

The number of pulse pairs transmitted by the interrogator will depend on whether the interrogator is in search mode trying to establish a link with a particular DME beacon or track mode, after contact has been made. In search mode the interrogator sends out a greater number of pulses and attempts to determine whether its transmit sequence is replied to. Once a reply sequence has been established the interrogator knows how the time delay at that time between sending a pulse pair and receiving a response thereto. The interrogator can then switch to track mode in which a time gate, based on the last known time delay between transmission and receiving a reply, can be applied to the interrogator receive channel to aid in identifying replies to its transmitted pulse pairs. The use of time gating allows fewer pulse pairs to be transmitted.

Clearly with more aircraft interrogating the transponder at the same time the number of replies generated will increase (up a maximum). The number of pulse pairs that arrive when the transponder is dealing with a previous pulse and therefore receive no reply will also increase and the interrogator reply efficiency will decrease.

The transponder measures the rate of replies that it generates and this is a measure of beacon loading. There is an upper limit for the reply rate and the DME beacon will reduce its own sensitivity so that this upper limit is not breached. Therefore if the beacon transponder is experiencing too high a number of interrogations it will reduce its sensitivity and therefore only receive higher power interrogations. As the power of each interrogator is largely fixed this generally means that the beacon with only identify interrogations from closer aircraft and will therefore only respond to those interrogations.

The beacon generates its own internal interrogations known as monitor interrogations. The beacon counts the number of responses it gets to these monitor interrogations and uses this number to determine its own measure of reply efficiency. If the reply efficiency falls below 70% (or higher for specific DMEs in specific modes) the beacon generates an alarm. The reply efficiency is a measure of the degree to which a DME transponder replies to valid interrogations received by that transponder.

The reply efficiency of the transponder depends on how many interrogations it thinks it receives. Interference can effect the reply efficiency of the transponder and of the system in various ways.

Interference which masks a valid interrogation received, so that the beacon does not recognise it as a valid interrogation, will obviously reduce the interrogator's reply efficiency. This type of interference will also mask the beacon's internal monitor interrogations as these are generated at the beacon antenna and are indistinguishable from external interrogations. The beacon will therefore detect a decrease in reply efficiency.

Further interference which is sufficiently like a single interrogation pulse will cause the beacon to shut down for the SDES period and may prevent the receiver from detecting a valid interrogation pulse. In this case the first pulse of a valid interrogation would be prevented from reaching the receiver and would therefore not generate a reply. This would reduce the reply efficiency accordingly.

There may be general RF noise. Low level noise will be below the sensitivity of the transponder and occasional high power noise will generally not have the characteristics of a pulse pair and so will be ignored. Pulse pairs received by the transponder that are of sufficient strength will be distinguishable above the noise.

Other interference could arise from an interrogator on another aircraft trying to interrogate a different DME beacon. For instance two DME beacons may share the same interrogation frequency but operate in different modes, i.e. with a different pulse pair spacing. A DME may therefore receive pulse pairs from an aircraft interrogator at the same frequency but at a different spacing. The DME will identify an individual pulse as a DME interrogation pulse and react accordingly, i.e. it will shut down for a short period and look for a second pulse at the correct spacing. The second pulse will not be at the correct spacing however so no reply will be generated.

It may also be that emissions from another RF communication device produces signals that appear to be a pulse pair having the correct spacing. After receipt of this type of interference the transponder will react as it would to a valid interrogation. A reply pulse pair is generated which does not correspond to any actual interrogation.

The presence of interference therefore can clearly effect reply efficiency of the beacon but the beacon may not be able to identify interference as such. Even if the beacon does realise that its reply efficiency has reduced, the information stored therein gives no indication of the source of the interference. It should be noted that the description above just gives an indication of the types of interference that may be present and the effect it may have on the DME transponder. There are numerous subtle effects interference may have on DME transponders and interference may effect different makes of DME beacon in different ways.

The present invention therefore provides a reliable, non-invasive method and apparatus for checking the operation of a DME transponder and identifying any interference and/or determining whether signals from another RF system are reducing the system efficiency of the DME system which does not disrupt normal operation of the system.

With regard to FIG. 3 the principle of the invention will be described. To determine the operation of a DME beacon 4 an analyser 6 is located in the vicinity of the DME beacon. Ideally the analyser 6 should be co-located with the DME beacon but this is not always possible and it is a feature of the present invention that the analyser can be located remotely to the DME beacon 4 and still operate. Thus, for the purposes of DME monitoring access to the DME site is not always needed. The analyser should be located so that it has line of sight to the DME beacon and also so that it can receive substantially the same signals as the DME beacon.

The analyser 6 records all signals incident at the analyser on the interrogation frequency for that particular DME beacon. The analyser therefore records all signals that are incident at the DME beacon, such as transmitted by aircraft 2, 8 and also any possible interference such as transmitted by another RF system 10. The analyser 6 also records all signals transmitted by the DME beacon on the reply frequency.

The analyser processes the signals received on the interrogation frequency to identify pulses which correspond to DME interrogation pulses (including DME pulse pairs at the incorrect spacing for that particular transponder) received at that DME beacon 4 from an aircraft interrogator. Further it also looks at additional characteristics such as the rise time, the overall shape of the pulse and other pulse characteristics as this helps distinguish actual DME interrogations from DME like interference. However looking at the pulse characteristics can also allow the analyser to identify pulses relating to known RF sources. For instance, JTIDS pulses tend to have a characteristic rise time and width (wider than DME interrogation pulses). The analyser may be designed to be able to identify such pulses. This will enable the analyser to determine the amount of any JTIDS activity present.

The analyser also processes the signals received on the reply frequency to determine the reply pulse pairs transmitted by the DME beacon transponder and their time of arrival.

In order to determine the reply efficiency of the beacon it is necessary to determine which of the valid interrogation pulse pairs identified have been replied to by the beacon. It is therefore necessary to correlate reply pulse pairs with an interrogation pulse pair. This could be performed in situ by a processor within the analyser or the analyser may store the data relating to the pulses for subsequent processing or transmit the data relating to the pulses to a remote location for processing.

In any case, as explained above, the time between the DME beacon receiving a valid interrogation and transmitting a reply is known. Therefore where the analyser is co-located with the DME beacon during data acquisition correlation is relatively straight forward and involves identifying the interrogation pulses which were received the correct reply time before a reply pulse was identified. However where the analyser is not co-located with the DME beacon on data acquisition the correlation step is more complicated.

Where the analyser is not co-located with the DME beacon the interrogation pulse pairs from an aircraft may arrive at the analyser at a different time to the DME beacon transponder. Further there will be a short time delay between the DME transponder transmitting a reply pulse pair and that reply pulse pair arriving at the analyser. For example, with reference to FIG. 3 interrogation pulse pairs transmitted by a first aircraft 2 will arrive at the analyser 6 before they arrive at the DME beacon 4. However a pulse pair transmitted by a second aircraft 8 will reach the DME beacon 4 before it reaches the analyser 6. In both cases if the DME beacon identifies the interrogation as valid and transmits a reply pulse after the standard fixed delay the analyser will not detect this reply pulse until it has traveled between the beacon and analyser. Thus the time difference between receipt of an interrogation at the analyser and the receipt of a reply to that interrogation will be equal to the fixed time delay introduced by the beacon plus a variable amount depending on the time difference between the signal being received at the beacon and at the analyser and the time of flight for a reply transmitted by the beacon to reach the analyser. Consider an interrogation transmitted from aircraft 2. This reaches the analyser first at a time t1. A short while later, at t2, the interrogation reaches the beacon. The beacon applies the fixed time delay and replies at a time t3. After travelling from the beacon to the analyser the reply pulse is received by the analyser at a time t4. As far as the beacon is concerned the time between pulse pair arrival and reply, t3−t2, is equal to the fixed time delay. However as recorded at the analyser the time between interrogation arrival and response is t4−t1. The exact difference will depend on the separation of the DME beacon and analyser and the relative distances of each to the interrogator. A separation of the beacon and analyser of 150 metres could mean a variable delay of up to one microsecond in addition to the fixed delay introduced by the beacon itself which is typically 50 μs. Whilst the separation between the beacon and the analyser can be measured the origin of the interrogation pulse pair is unknown. The analyser takes account of the physical separation from the beacon and applies a tolerance to the arrival time of a reply following the arrival time of an interrogation. The correlation process will therefore identify which valid interrogation pulses received by the beacon received a response and which did not.

It will be apparent from the foregoing that where a single analyser is used and the analyser is not co-located with the DME beacon there will be a small uncertainty, related to the separation distance, in determining the time of arrival of pulses at the DME transponder. If a particular pulse interrogation can be uniquely identified with a reply then knowledge of the reply arrival time and separation can remove the uncertainty. However it is possible that a reply could be associated with more than one interrogation pulse. Also if a valid interrogation pulse pair is received but the DME transponder does not reply there may be uncertainty whether one of pulses was received during or after transponder dead time. Were the pulse received during the dead time then a reply would not be expected. However were the pulse received outside of the dead time then the fact no reply was received could indicate that the sensitivity of the DME transponder had been adjusted so that it was no longer sensitive to pulses of that power or it could indicate some other interference or error.

To overcome the issues associated with such uncertainty it is possible to deploy more than one analyser, each analyser being located at a different location with respect to the DME beacon. FIG. 5 shows a plan view of a DME beacon 4 surrounded by five separate analysers 30a-e at different positions. An interrogation from an aircraft (not shown) will be detected by the analysers 30a-e at a set of different times. If the DME beacon recognises the interrogation as valid and issues a reply the reply pulse pair will also be detected by each analyser 30a-e. The received reply can be used to correlate the interrogations received by each analyser.

Were the interrogation received at the DME beacon at exactly the same time that it was received at an analyser the interrogation-reply spacing detected at the analyser would be equal to the fixed delay introduced by the DME beacon T₀ plus the time of flight delay due to the analyser-beacon spacing Tₛ. Each analyser 30a-e therefore measures the time difference T_{d} between the expected spacing of the interrogation and reply for simultaneous arrival and that actually detected. Each value of T_{d} represents a Time Distance of Arrival (TDOA) measurement with respect to the DME beacon that can be used in a multilateration algorithm.

As the skilled person will be aware multilateration is a known technique for determining location of a target which requires that a signal (or event) is received by several sensors such that the time difference of arrival can be measured. This usually means that the signal has to be uniquely determined at each sensor and its time of arrival measured so that the time of arrival at each sensor can be compared to produce the TDOA values.

As will be appreciated from the foregoing however multilaterating using DME interrogations is difficult as all DME interrogations are intended to look the same and so will only vary in power level. By using the DME in effect as a datum sensor a reply indicates that the event was determined by the datum.

In order to perform multilateration the value of T_{d} determined by each analyser needs be known and so these values should be communicated to a central multilateration processor 32, which could be separate to all the analysers or one analyser could act as the central multilateration processor. The multilateration processing could be done in real time or could be done by processing the data after the event.

The multilateration approach could also be used to determine the location of interference if the interference signal could be uniquely identified at each analyser. For instance, for detecting JTIDS pulses it is possible to use the known characteristics of the JTIDS pulse to determine a label for each pulse as will be described later.

An overall reply efficiency for the beacon can then be determined which is an external measure of efficiency. The reply efficiency, and any variation therein, can also be tracked against other contemporaneous signals, such as detected JTIDS pulses. For instance any variation in reply efficiency of the beacon during periods of high JTIDS activity as compared to periods of low JTIDS activity could be looked at. Clearly the amount of actual DME interrogation activity must also be taken into account as a drop in reply efficiency during a period of high JTIDS activity may be due to interference effects or may be because the amount of DME activity also increased. Where multiple analysers are used and the signals from particular aircraft can be identified it is also possible to determine a reply efficiency to interrogations from that aircraft alone.

In a more sophisticated analysis the processor models the behaviour of the DME beacon. The response of the DME beacon to individual signals is predictable and can be incorporated into the model. Knowing the number and nature of pulses that are received by the interrogation receiver, the processor can then model the DME response and determine to which interrogations the DME would be expected to respond. The model may also produce a measure of what the DME beacon would calculate to be its own reply efficiency.

The model contains a representation of the sensitivity of the DME receiver and a representation of the sequence of events that occur upon detection of a pulse. When the analyser detects a pulse it is compared to the minimum detectable signal level of the model. When a valid pulse is input to the model, the process of decoding an interrogation and generating a reply is triggered. The model takes account of the SDES period generated upon detection of a pulse, includes the expected spacing of interrogation pulses and determines if a valid interrogation has been received. The model also takes account of all other pulses on the interrogation frequency including DME pulses on the wrong channel, non-DME pulses such as JTIDS and the model's own internal monitor interrogations.

Characteristics of specific makes of DME are also included such as the appearance of signals in the interrogations receiver due to transmissions in the reply transmitter.

FIG. 4 shows a schematic of the analyser and processor of the present invention. The apparatus comprises two main parts a data recording unit 40 and processing unit 42. The data recording unit comprises an RF antenna assembly 44 for receiving radio frequency signals. Conveniently a DME antenna assembly is used to ensure that the analyser receives the same signals as the DME transponder but any antenna assembly which will achieve the same scope of coverage could be used. In some embodiments a set of directional antennas may be used. The directional antennas could be combined to give the same degree of coverage but would also allow information regarding the direction of incidence of the signals to be used. This could aid in the correlation of interrogations with replies where the analyser is not co-located with the beacon and/or could allow information regarding the direction of incidence of interference to be determined which could aid in identifying the cause of any such interference.

The antenna assembly is connected to a RF receiver 46 adapted to be sensitive to low level signals at the interrogation frequency of the DME beacon. The antenna assembly is also connected to a RF receiver 48 which is tuned to the reply frequency of the DME beacon. The output of each receiver passes through an amplifier 50, 52 to a data acquisition board 54. The data acquisition board has a fast sampling rate, for example about 5 MHz.

Due to the very fast sampling rate it is not practical to record data for long periods of time as the large amount of data collected would require a very large memory. Similarly it is not presently practical to stream the data to a remote storage at that sampling rate. Input data is therefore collected for a short period of time, for instance, up to 10 seconds and then processed by a processor 56 to determine pulse events of interest. Only data relevant to pulse events of interest are stored in memory 58. In some embodiments, the processing of the raw sampled data to determine pulse events may be done in hardware rather than software. In this case the pulse events of interest can be recorded for long periods of time, because of the data reduction, for instance several hours.

The processor looks for pulses which are characteristic of any DME interrogations and also other pulse events of interest in the data from the interrogation channel. These may be anything that is similar to a DME interrogation pulse and/or may be a pulse type expected from another known RF system. As mentioned there is a desire to determine whether JTIDS activity effects DME efficiency. Therefore the pulses of interest may be pulses which are characteristic of JTIDS pulses. The signals produced in JTIDS operation can be determined by monitoring a system in use and analysed to determine certain characteristics which can then be used by the processor to identify likely JTIDS pulses in the data acquired on the interrogation channel.

For the reply channel the pulse events of interest are reply pulse pairs transmitted by the DME transponder.

The processor therefore identifies all pulses of interest occurring in the input data acquired on the interrogation channel and the reply channel and records the pulse data and the time of arrival.

Once the data has been processed to identify all pulse events of interest, and the appropriate data recorded, another period of data can be acquired and processed. In this way several data is acquired in separate snapshots but only the pulse events of interest are recorded or transmitted for further processing. This pre-processing therefore significantly reduces the data requirements for storage and/or transmission. Collecting data in bursts does mean there are periods where no data is collected, although this may not be significant in terms of measuring general performance, but making use of hardware processing to identify the pulse events will allow this process to happen continually.

The data relating to the pulse events of interest is then passed to the processing unit 42. The processing unit may be located within the same apparatus as the data recording unit and the device may be adapted to do perform the processing in situ. Alternatively the data recording unit may be a stand alone piece of equipment which is placed in the field to collect and store data for subsequent analysis. In which case memory 58 may be an internal storage medium such for storing the data relating to the pulse events of interest for collection. Alternatively the data recording unit may have a communication link to a remote processing unit and memory 58 is a temporary memory for storing the data for transmission.

Processor 60 analyses the data relating to the pulse events of interest. The processor identifies DME pulses, correlates interrogation pulse pairs with reply pulse pairs and determines various measures of performance as described above. From a measure of valid interrogations received and those responded to it obtains a measure of the DME beacon transponder reply efficiency. The data is also fed into a DME beacon model 62 which may be implemented in software or may be a hardware model of the DME beacon processor. The processor 60 also determines what the DME beacon transponder took its own internal reply efficiency to be.

The invention has been described above with regard to monitoring the operation of a DME transponder beacon. The apparatus and method of the present invention is more general however and the invention extends to monitoring the operation of any radio frequency navigation aid, for instance the invention could have applicability to monitoring the operation of ILS systems, Secondary Surveillance Radar (SSR) and emergency services networks. The pulses events of interest may be different for ILS or SSR system—and here the term pulse event should be taken to mean any waveform characteristic, but the present invention can monitor the RF traffic and identify the events of interest corresponding to the operation of the systems under test.

As mentioned above the present invention can also be employed to determine the location of a source of possible interference, such a JTIDS pulses. FIG. 6 illustrates how the present invention can be used to perform multilateration on JTIDS pulses to determine the original thereof. A plurality of sensors 64₁-64ₙ are spatially separated in the area of interest. Within each sensor, 64 an RF receiver, or sensor, detects 66 transmissions within the JTIDS band. One of the JTIDS frequency channels is selected in a frequency selection process 68 so that only pulses on that frequency channel are processed further. Each pulse detected on the chosen channel is decoded 70 in order to determine the 32 bits or chips contained therein. As is known for JTIDS pulses the 32 chips are encoded within the pulse using a known frequency modulation scheme. The demodulator is able to detect this modulation and determine the modulation pattern. The modulation pattern yields a 32 bit number which is used to identify the pulse when received at several independent sensors. This 32 bit number or pulse label is combined with time of arrival information in a message formation step 72. The most basic determination of arrival time of the pulse can be taken from the rising edge of the pulse as is well known. The pulse label and time of arrival are then sent to the multilateration central processor 74 which uses the pulse labels from each sensor to identify corresponding pulses and then uses the relevant times of arrival in a multilateration step as is well known,

1. A method of monitoring the operation of a DME beacon comprising the steps of:
arranging an RF receiver to receive substantially the same RF signals as received by the DME beacon on its interrogation frequency and to receive any RF signals transmitted by the beacon on its reply frequency;
processing the RF signals received on the interrogation frequency to identify any DME pulse pair interrogations;
processing the RF signals received on the reply frequency to identify any DME pulse pair replies; and
calculating a reply efficiency for the DME beacon.

2. A method as claimed in claim 1 comprising the additional step of processing the RF signals received on the interrogation frequency to identify any pulse events of interest.

3. A method as claimed in claim 2 wherein the pulse events of interest are RF signals matching predetermined characteristics.

4. A method as claimed in claim 3 wherein the predetermined characteristics are characteristic of a known RF system.

5. A method as claimed in claim 2 wherein the pulse events of interest include JTIDS communication pulses.

6. A method as claimed in claim 1 further comprising the step of correlating identified DME pulse pair replies with the relevant DME pulse pair interrogation.

7. A method as claimed in claim 1 further comprising the step of locating at least one additional RF receiver to receive the same RE signals as received by the DME beacon on its interrogation frequency and to receive any RF signals transmitted by the beacon on its reply frequency.

8. A method as claimed in claim 7 wherein the method comprises the step of correlating the signals received at each RF receiver to determine the time of arrival of the signals at the DME beacon.

9. A method as claimed in claim 7 further comprising the step of identifying a particular pulse pair reply transmitted by the DME beacon in the signals received by each RF receiver and the corresponding DME interrogation pulse pair generating said reply and determining the time difference between arrival of said interrogation and said reply at each RF receiver.

10. A method as claimed as claim 9 further comprising the step of determining the difference in arrival time of said interrogation pulse pair at each RF receiver.

11. A method as claimed in claim 10 comprising the step of performing multilateration using the difference in arrival time of said interrogation pulse pair at each RF receiver to determine the relative location of the source of said interrogation pulse pair.

12. A method as claimed in claim 11 wherein the relative location of the source of said interrogation pulse pair is used to identify further interrogation pulse pairs from the same interrogation source.

13. A method as claimed in claim 1 wherein the method includes the step of only storing or transmitting data relating to identified DME interrogation pulses, identified reply pulses and any pulse events of interest for subsequent analysis.

14. A method as claimed in claim 13 wherein the data transmitted or stored comprises the characteristics of the pulse and the time of arrival.

15. A method as claimed in claim 1 wherein details of the identified DME pulse pair interrogations, DME pulse pair replies and pulse events of interest is input into a model of the DME beacon.

16. A method as claimed in claim 15 wherein the model determines the DME beacon's internal measure of reply efficiency.

17. A method as claimed in claim 2 wherein the reply efficiency is analysed to determine any correlation with pulse events of interest.

18. An apparatus for monitoring the operation of a DME beacon comprising an RF receiver for receiving RF signals at the interrogation frequency of the DME beacon and RF signals at the reply frequency of the DME beacon, an input data processor for processing the RF signals incident at the interrogation frequency to identify any DME interrogation pulse pairs and processing the RF signals incident at the reply frequency to identify any DME reply pulse pairs and storing pulse data relating to identified DME pulse pairs.

19. An apparatus as claimed in claim 18 wherein the input data processor also processes the RF signals incident at the interrogation frequency to identify any pulse events of interest and stores pulse data relating to identified pulse events of interest.

20. An apparatus as claimed in claim 18 wherein the stored pulse data comprises pulse characteristics and time of arrival.

21. An apparatus as claimed in claim 18 further comprising a pulse data processor for correlating identified DME reply pulses with identified DME pulse interrogations.

22. An apparatus as claimed in claim 21 wherein the pulse data processor produces an indication of the DME beacon reply efficiency.

23. An apparatus as claimed in claim 21 wherein the input data processor is the same processor as the pulse data processor.

24. An apparatus as claimed in claim 18 wherein the apparatus further comprises a model means acting on the pulse data for modelling the operation of the DME beacon.

25. A method of aircraft location comprising the steps of arranging a plurality of RF receivers around a DME beacon, each being arranged to receive substantially the same RF signals as received by the beacon on the interrogation frequency and transmitted by the beacon on the reply frequency, processing the signals received at each RF receiver to determine a reply pulse pair transmitted by the DME beacon and identify the relevant interrogation pulse pair received, determining a time difference of arrival for the relevant interrogation pulse pair at each RF receiver relative to the DME transponder and performing multilateration using each determined time difference of arrival to determine the relative location of the source of the relevant interrogation pulse.

26. A method of identifying a source of non-DME pulses transmitted within the DME frequency band comprising the steps of: locating a plurality of RF receivers at spatially separated locations, detecting, for at least one predetermined frequency channel, any pulses received on that frequency channel; processing each pulse received to derive a label based on the pulse modulation; using said pulse labels to identify the time of arrival of said pulse at each RF receiver; and performing multilateration on the identified times of arrival.

27. A method as claimed in claim 26 further comprising the step of ignoring any pulses which do not match a predetermined characteristic.

28. A method as claimed in claim 27 wherein the non-DME pulses are JTIDS pulses.

29. A method as claimed in claim 28 wherein the step of deriving a label based on the 32 bit modulation sequence.
